(19) United States
(12) Patent Application Publication
(10) Pub. No.: US 2025/0271681 A1
(43) Pub. Date: Aug. 28, 2025

(54) Display with Collimating Optics Including an Annular Mirror

(71) Applicant: Apple Inc., Cupertino, CA (US)

(72) Inventors: Graham B. Myhre, Campbell, CA (US); Bradley C. Steele, La Jolla, CA (US); Graham C. Nelson, San Diego, CA (US); Scott M. DeLapp, San Diego, CA (US)

(21) Appl. No.: 18/980,043

(22) Filed: Dec. 13, 2024

Related U.S. Application Data
(60) Provisional application No. 63/558,522, filed on Feb. 27, 2024.

(51) Int. Cl. G02B 27/09; G02B 6/34; G02B 27/01

(52) U.S. Cl. CPC G02B 27/0983; G02B 6/34; G02B 27/0172

(57) ABSTRACT

An electronic device may include a display module that generates light and an optical system that redirects the light towards an eye box. The system may include an input coupler on a waveguide and collimating optics that collimate the light between the light exiting a display module and the light reaching the input coupler. The collimating optics may include a first mirror with a convex surface on an opposing side of the waveguide as the display module. The collimating optics may include a second mirror with an annular footprint on the same side of the waveguide as the display module. The second mirror may have a concave surface and may laterally surround the display module. The input coupler may have an annular footprint that laterally surrounds the first mirror.

This application claims the benefit of U.S. provisional patent application No. 63/558,522 filed Feb. 27, 2024, which is hereby incorporated by reference herein in its entirety.

### BACKGROUND

This relates generally to optical systems and, more particularly, to optical systems for displays.

Electronic devices may include displays that present images to a user's eyes. For example, devices such as virtual reality and augmented reality headsets may include displays with optical elements that allow users to view the displays.

It can be challenging to design devices such as these. If care is not taken, the components used in displaying content may be unsightly and bulky and may not exhibit desired levels of optical performance.

### SUMMARY

A display system may include a waveguide having first and second opposing sides, a first mirror on the first side of the waveguide, a display module on the second side of the waveguide that produces image light, and a second mirror on the second side of the waveguide. The second mirror may have an annular footprint with a central opening and the display module and the first mirror may overlap the central opening.

A display system may include a waveguide having first and second opposing sides, a first mirror on the first side of the waveguide, a surface relief grating on the first side of the waveguide that has a first annular footprint with a first central opening that overlaps the first mirror, a display module on the second side of the waveguide that produces image light that passes through the first central opening to reach the first mirror, and a second mirror on the second side of the waveguide that receives the image light from the first mirror.

A display system may include a waveguide having first and second opposing sides, a display module that produces image light, an input coupler on the waveguide that couples the image light into the waveguide, and collimating optics that collimate the image light from the display module for the input coupler. The collimating optics may include a first mirror on the first side of the waveguide and a second mirror on the second side of the waveguide.

### BRIEF DESCRIPTION OF THE DRAWINGS

FIG. 1 is a diagram of an illustrative system having a display in accordance with some embodiments.

FIG. 2 is a top view of an illustrative optical system for a display having a waveguide with an input coupler in accordance with some embodiments.

FIG. 3 is a top view of an illustrative optical system for a display having collimating optics that include an annular mirror in accordance with some embodiments.

FIGS. 4A and 4B are side views of the display of FIG. 3 in accordance with some embodiments.

FIG. 5 is a top view of an illustrative optical system for a display having collimating optics that include concentric annular mirrors in accordance with some embodiments.

FIG. 6 is a side view of the concentric annular mirrors of FIG. 5 in accordance with some embodiments.

### DETAILED DESCRIPTION

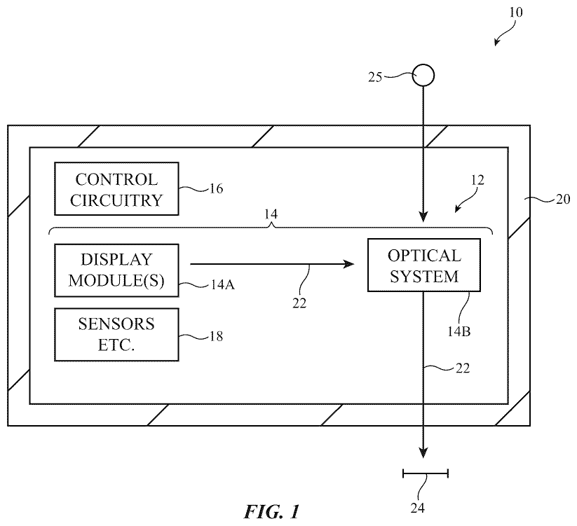

An illustrative system having a device with one or more near-eye display systems is shown in FIG. 1. System 10 may be a head-mounted device having one or more displays such as near-eye displays 14 mounted within support structure (housing) 20. Support structure 20 may have the shape of a pair of eyeglasses (e.g., supporting frames), may form a housing having a helmet shape, or may have other configurations to help in mounting and securing the components of near-eye displays 14 on the head or near the eye of a user. Near-eye displays 14 may include one or more display modules such as display modules 14A and one or more optical systems such as optical systems 14B. Display modules 14A may be mounted in a support structure such as support structure 20. Each display module 14A may emit light 22 (image light) that is redirected towards a user's eyes at eye box 24 using an associated one of optical systems 14B.

The operation of system 10 may be controlled using control circuitry 16. Control circuitry 16 may include storage and processing circuitry for controlling the operation of system 10. Circuitry 16 may include storage such as hard disk drive storage, nonvolatile memory (e.g., electrically-programmable-read-only memory configured to form a solid state drive), volatile memory (e.g., static or dynamic random-access-memory), etc. Processing circuitry in control circuitry 16 may be based on one or more microprocessors, microcontrollers, digital signal processors, baseband processors, power management units, audio chips, graphics processing units, application specific integrated circuits, and other integrated circuits. Software code (instructions) may be stored on storage in circuitry 16 and run on processing circuitry in circuitry 16 to implement operations for system 10 (e.g., data gathering operations, operations involving the adjustment of components using control signals, image rendering operations to produce image content to be displayed for a user, etc.).

System 10 may include input-output circuitry such as input-output devices 12. Input-output devices 12 may be used to allow data to be received by system 10 from external equipment (e.g., a tethered computer, a portable device such as a handheld device or laptop computer, or other electrical equipment) and to allow a user to provide head-mounted device 10 with user input. Input-output devices 12 may also be used to gather information on the environment in which system 10 (e.g., head-mounted device 10) is operating. Output components in devices 12 may allow system 10 to provide a user with output and may be used to communicate with external electrical equipment. Input-output devices 12 may include sensors and other components 18 (e.g., image sensors for gathering images of real-world object that are digitally merged with virtual objects on a display in system 10, accelerometers, depth sensors, light sensors, haptic output devices, speakers, batteries, wireless communications circuits for communicating between system 10 and external electronic equipment, etc.).

Display modules 14A may include reflective displays (e.g., liquid crystal on silicon (LCOS) displays, digital-micromirror device (DMD) displays, or other spatial light modulators), emissive displays (e.g., micro-light-emitting diode (uLED) displays, organic light-emitting diode (OLED) displays, laser-based displays, etc.), or displays of other types. Light sources in display modules 14A may include uLEDs, OLEDs, LEDs, lasers, combinations of these, or any other desired light-emitting components.

Optical systems 14B may form lenses that allow a viewer (see, e.g., a viewer's eyes at eye box 24) to view images on display(s) 14. There may be two optical systems 14B (e.g., for forming left and right lenses) associated with respective left and right eyes of the user. A single display 14 may produce images for both eyes or a pair of displays 14 may be used to display images. In configurations with multiple displays (e.g., left and right eye displays), the focal length and positions of the lenses formed by components in optical system 14B may be selected so that any gap present between the displays will not be visible to a user (e.g., so that the images of the left and right displays overlap or merge seamlessly).

If desired, optical system 14B may contain components (e.g., an optical combiner, etc.) to allow real-world image light from real-world images or objects 25 to be combined optically with virtual (computer-generated) images such as virtual images in image light 22. In this type of system, which is sometimes referred to as an augmented reality system, a user of system 10 may view both real-world content and computer-generated content that is overlaid on top of the real-world content. Camera-based augmented reality systems may also be used in device 10 (e.g., in an arrangement which a camera captures real-world images of object 25 and this content is digitally merged with virtual content at optical system 14B).

System 10 may, if desired, include wireless circuitry and/or other circuitry to support communications with a computer or other external equipment (e.g., a computer that supplies display 14 with image content). During operation, control circuitry 16 may supply image content to display 14. The content may be remotely received (e.g., from a computer or other content source coupled to system 10) and/or may be generated by control circuitry 16 (e.g., text, other computer-generated content, etc.). The content that is supplied to display 14 by control circuitry 16 may be viewed by a viewer at eye box 24.

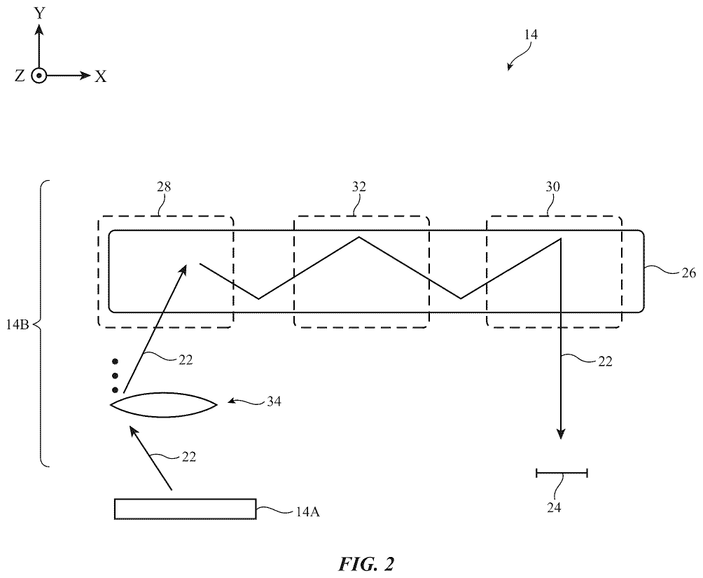

FIG. 2 is a top view of an illustrative display 14 that may be used in system 10 of FIG. 1. As shown in FIG. 2, near-eye display 14 may include one or more display modules such as display module 14A and an optical system such as optical system 14B. Optical system 14B may include optical elements such as one or more waveguides 26. Waveguide 26 may include one or more stacked substrates (e.g., stacked planar and/or curved layers sometimes referred to herein as waveguide substrates) of optically transparent material such as plastic, polymer, glass, etc.

If desired, waveguide 26 may also include one or more layers of holographic recording media (sometimes referred to herein as holographic media, grating media, or diffraction grating media) on which one or more diffractive gratings are recorded (e.g., holographic phase gratings, sometimes referred to herein as holograms). A holographic recording may be stored as an optical interference pattern (e.g., alternating regions of different indices of refraction) within a photosensitive optical material such as the holographic media. The optical interference pattern may create a holographic phase grating that, when illuminated with a given light source, diffracts light to create a three-dimensional reconstruction of the holographic recording. The holographic phase grating may be a non-switchable diffractive grating that is encoded with a permanent interference pattern or may be a switchable diffractive grating in which the diffracted light can be modulated by controlling an electric field applied to the holographic recording medium. Multiple holographic phase gratings (holograms) may be recorded within (e.g., superimposed within) the same volume of holographic medium if desired. The holographic phase gratings may be, for example, volume holograms or thin-film holograms in the grating medium. The grating media may include photopolymers, gelatin such as dichromated gelatin, silver halides, holographic polymer dispersed liquid crystal, or other suitable holographic media.

Diffractive gratings on waveguide 26 may include holographic phase gratings such as volume holograms or thin-film holograms, meta-gratings, or any other desired diffractive grating structures. The diffractive gratings on waveguide 26 may also include surface relief gratings formed on one or more surfaces of the substrates in waveguides 26, gratings formed from patterns of metal structures, etc. The diffractive gratings may, for example, include multiple multiplexed gratings (e.g., holograms) that at least partially overlap within the same volume of grating medium (e.g., for diffracting different colors of light and/or light from a range of different input angles at one or more corresponding output angles).

Optical system 14B may include collimating optics such as collimating optics 34. Collimating lens 34 may include one or more lens elements and/or mirrors that help direct image light 22 towards waveguide 26. If desired, display module 14A may be mounted within support structure 20 of FIG. 1 while optical system 14B may be mounted between portions of support structure 20 (e.g., to form a lens that aligns with eye box 24). Other mounting arrangements may be used, if desired.

As shown in FIG. 2, display module 14A may generate light 22 associated with image content to be displayed to eye box 24. Light 22 may be collimated using collimating optics 34. Optical system 14B may be used to present light 22 output from display module 14A to eye box 24.

Optical system 14B may include one or more optical couplers such as input coupler 28, cross-coupler 32, and output coupler 30. In the example of FIG. 2, input coupler 28, cross-coupler 32, and output coupler 30 are formed at or on waveguide 26. Input coupler 28, cross-coupler 32, and/or output coupler 30 may be completely embedded within the substrate layers of waveguide 26, may be partially embedded within the substrate layers of waveguide 26, may be mounted to waveguide 26 (e.g., mounted to an exterior surface of waveguide 26), etc.

The example of FIG. 2 is merely illustrative. One or more of these couplers (e.g., cross-coupler 32) may be omitted. Optical system 14B may include multiple waveguides that are laterally and/or vertically stacked with respect to each other. Each waveguide may include one, two, all, or none of couplers 28, 32, and 30. Waveguide 26 may be at least partially curved or bent if desired.

Waveguide 26 may guide light 22 down its length via total internal reflection. Input coupler 28 may be configured to couple light 22 from display module 14A (lens 34) into waveguide 26, whereas output coupler 30 may be configured to couple light 22 from within waveguide 26 to the exterior of waveguide 26 and towards eye box 24. For example, display module 14A may emit light 22 in direction +Y towards optical system 14B. When light 22 strikes input coupler 28, input coupler 28 may redirect light 22 so that the light propagates within waveguide 26 via total internal reflection towards output coupler 30 (e.g., in direction X). When light 22 strikes output coupler 30, output coupler 30 may redirect light 22 out of waveguide 26 towards eye box 24 (e.g., back along the Y-axis). In scenarios where cross-coupler 32 is formed at waveguide 26, cross-coupler 32 may redirect light 22 in one or more directions as it propagates down the length of waveguide 26, for example.

Input coupler 28, cross-coupler 32, and/or output coupler 30 may be based on reflective and refractive optics or may be based on holographic (e.g., diffractive) optics. In arrangements where couplers 28, 30, and 32 are formed from reflective and refractive optics, couplers 28, 30, and 32 may include one or more reflectors (e.g., an array of micromirrors, partial mirrors, or other reflectors). In arrangements where couplers 28, 30, and 32 are based on holographic optics, couplers 28, 30, and 32 may include diffractive gratings (e.g., volume holograms, surface relief gratings, etc.).

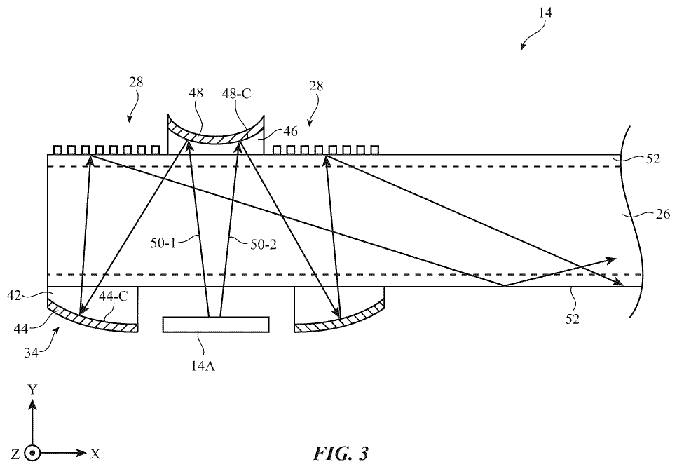

FIG. 3 is a top view of an illustrative display 14 that includes collimating optics with reflective mirrors. As shown, display module 14A is positioned on a first side of waveguide 26. Display module 14A emits light in the positive Y-direction through waveguide 26 to a mirror 48 that is positioned on a second, opposing side of waveguide 26. Mirror 48 therefore overlaps display panel module 14A in the Y-direction.

Mirror 48 has a surface with convex curvature (sometimes referred to as convex surface 48-C) configured to reflect the light received from display module 14A in the negative Y-direction. Surface 48-C may be referred to as facing display module 14A. After being reflected by convex surface 48-C, the light may pass through the waveguide in the negative Y-direction towards mirror 44. Mirror 44 laterally surrounds display module 14A within the XZ-plane. In other words, mirror 44 has an annular footprint with a central opening and display module 14A and mirror 48 overlap the central opening in the Y-direction. Display module 14A may be referred to as being positioned within the central opening of mirror 44. Mirror 44 may sometimes be referred to as a ring-shaped mirror or annular mirror.

Mirror 44 has a surface with concave curvature (sometimes referred to as concave surface 44-C) configured to reflect the light received from mirror 48 in the positive Y-direction towards input coupler 28. Surface 44-C may be referred to as facing input coupler 28. After being reflected by concave surface 44-C, the light may pass through the waveguide in the positive Y-direction to input coupler 28. In the example of FIG. 3, input coupler 28 is formed from a surface relief grating. Input coupler 28 laterally surrounds mirror 48 within the XZ-plane. In other words, input coupler has an annular footprint with a central opening and mirror 48 and display module 14A overlap the central opening in the Y-direction. Mirror 48 may be referred to as being positioned within the central opening of input coupler 28. Input coupler 28 may sometimes be referred to as a ring-shaped input coupler or annular input coupler.

The input coupler 28 may receive light from mirror 44 and redirect the light so that the light propagates within waveguide 26 via total internal reflection (e.g., towards a cross coupler and/or output coupler 30 in the positive X-direction). If light is directed from input coupler 28 toward mirror 44, light in total internal reflection will not re-interact with mirror 44 and will continue down waveguide 26 toward output coupler 30.

Consider light rays 50-1 and 50-2 emitted by display module 14A. Ray 50-1 is emitted by display module 14A in the positive Y-direction. Ray 50-1 passes through the thickness of waveguide 26 a first time and is incident upon convex surface 48-C of mirror 48. Ray 50-1 subsequently passes through the thickness of waveguide 26 a second time and is incident upon concave surface 44-C of mirror 44. Ray 50-1 subsequently passes through the thickness of waveguide 26 a third time and is incident upon input coupler 28. Ray 50-1 is subsequently redirected by input coupler 28 in the positive X-direction to propagate within waveguide 26 via total internal reflection.

Ray 50-2 is emitted by display module 14A in the positive Y-direction. Ray 50-2 passes through the thickness of waveguide 26 a first time and is incident upon convex surface 48-C of mirror 48. Ray 50-2 subsequently passes through the thickness of waveguide 26 a second time and is incident upon concave surface 44-C of mirror 44. Rays 50-1 and 50-2 are incident upon concave surface 44-C on first and second opposing sides of display module 14A. Ray 50-2 subsequently passes through the thickness of waveguide 26 a third time and is incident upon input coupler 28. Rays 50-1 and 50-2 are incident upon input coupler 28 on first and second opposing sides of mirror 48. Ray 50-2 is subsequently redirected by input coupler 28 in the positive X-direction to propagate within waveguide 26 via total internal reflection.

Mirrors 44 and 48 may have a reflectance that is greater than 70%, greater than 80%, greater than 90%, greater than 95%, etc. The mirrors may be formed as coatings, films, or solid pieces. The mirrors may be attached or coated to one or more structures such as transparent structures 42 and 46 in FIG. 3. FIG. 3 shows an example where mirror 44 is coated on transparent structure 42. Transparent structure 42 has the same footprint as mirror 44. The transparent structure may be formed from transparent glass, plastic, etc. Transparent structure 42 may be attached to waveguide 26 (e.g., using optically clear adhesive). This example is merely illustrative and transparent structure may optionally be omitted if desired. When the transparent structure is omitted, there may be an air gap between waveguide 26 and mirror 44. In FIG. 3, transparent structure 42 is interposed between mirror 44 and waveguide 26. When the transparent structure is omitted, mirror 44 may be attached to an additional (transparent or opaque) structure that supports mirror 44 in a desired position adjacent to waveguide 26 (e.g., in the position shown in FIG. 3).

FIG. 3 shows an example where mirror 48 is coated on transparent structure 46. Transparent structure 46 has the same footprint as mirror 48. The transparent structure may be formed from transparent glass, plastic, etc. Transparent structure 46 may be attached to waveguide 26 (e.g., using optically clear adhesive). This example is merely illustrative and transparent structure may optionally be omitted if desired. When the transparent structure is omitted, there may be an air gap between waveguide 26 and mirror 48. In FIG. 3, transparent structure 46 is interposed between mirror 48 and waveguide 26. When the transparent structure is omitted, mirror 48 may be attached to an additional (transparent or opaque) structure that supports mirror 48 in a desired position adjacent to waveguide 26 (e.g., in the position shown in FIG. 3).

In the example of FIG. 3, transparent structure 42 has a convex surface that conforms to concave surface 44-C and a planar surface that is parallel to waveguide 26. This example is merely illustrative. Transparent structure 42 may, in general, have surfaces with any desired curvature. As one specific example, transparent structure 42 may have a convex surface that conforms to concave surface 44-C and an opposing concave surface. Transparent structure 42 may refract light from display module 14A to help collimate the light for input coupler 28.

Similarly, in the example of FIG. 3, transparent structure 46 has a concave surface that conforms to convex surface 48-C and a planar surface that is parallel to waveguide 26. This example is merely illustrative. Transparent structure 46 may, in general, have surfaces with any desired curvature. As one specific example, transparent structure 46 may have a concave surface that conforms to convex surface 48-C and an opposing convex surface. Transparent structure 46 may refract light from display module 14A to help collimate the light for input coupler 28. Either mirror 44 or mirror 48 may optionally be a Mangin mirror.

Waveguide 26 may optionally be encased in low-index cladding layers 52. The low-index cladding layers may be formed from a material having an index of refraction that is less than 1.3, less than 1.2, less than 1.1, etc. In contrast, the index of refraction of waveguide 26 may be greater than 1.8, greater than 2.0, etc. The difference in index of refraction between waveguide 26 and low-index layers 52 may therefore be greater than 0.5, greater than 0.7, greater than 0.9, etc. The low-index cladding layers may optionally overlap and conform to a surface relief grating that defines input coupler 28. The low-index cladding layers may be interposed between waveguide 26 and mirror 48, may be interposed between waveguide 26 and transparent structure 46, may be interposed between waveguide 26 and mirror 44, and/or may be interposed between waveguide 26 and transparent structure 42.

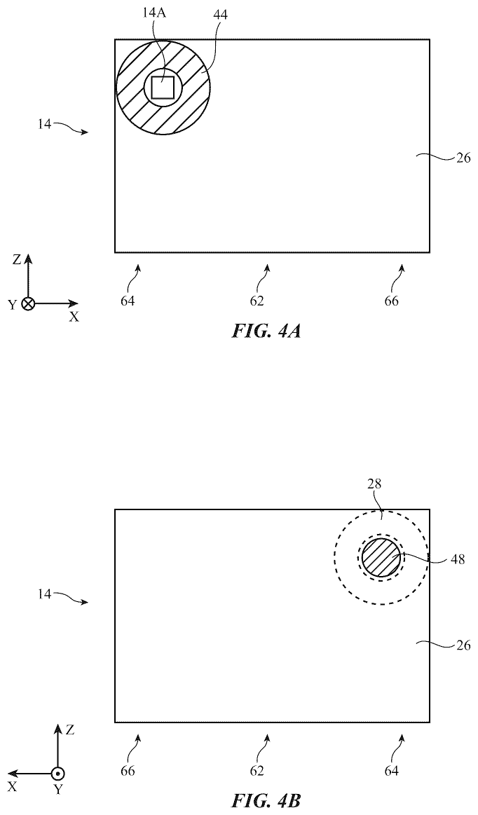

FIG. 4A is a side view of display 14 from a perspective looking in the positive Y-direction. FIG. 4A shows how display module 14A overlaps waveguide 26 in the Y-direction. Mirror 44 also overlaps waveguide 26 in the Y-direction. As shown in FIG. 4A, mirror 44 has an annular footprint with a central opening that overlaps display module 14A. Said another way, mirror 44 completely laterally surrounds display module 14A.

FIG. 4B is a side view of display 14 from a perspective looking in the negative Y-direction. FIG. 4B shows how mirror 48 overlaps waveguide 26 in the Y-direction. Input coupler 28 also overlaps waveguide 26 in the Y-direction. As shown in FIG. 4B, input coupler 28 has an annular footprint with a central opening that overlaps mirror 48. Said another way, input coupler 28 completely laterally surrounds mirror 48. The footprints of display module 14A and mirror 48 may overlap in the Y-direction. The footprints of input coupler 28 and mirror 44 may overlap in the Y-direction.

In the example of FIGS. 3, 4A, and 4B, display module 14A and annular mirror 44 are formed on the eye-box-side of waveguide 26. In other words, light is ultimately output from waveguide 26 towards eye box 24 in the negative Y-direction (as shown in FIG. 2). In FIG. 3, display panel 14A and annular mirror 44 are on the same side of waveguide 26 as eye box 24. This example is merely illustrative. If desired, the arrangement may be flipped with display panel 14A and annular mirror 44 instead being formed on the opposite side of waveguide 26 as eye box 24.

As shown in FIGS. 4A and 4B, waveguide 26 may have a central region 62, a first peripheral region 64, and a second peripheral region 66. Peripheral region 64 may sometimes be referred to herein as temple region 64 (e.g., because region 64 sits at or adjacent to the user's temple when the user is viewing the display). Peripheral region 66 may sometimes be referred to herein as nasal region 66 (e.g., because region 66 sits at or adjacent to the user's nose when the user is viewing the display).

In the example of FIGS. 3, 4A, and 4B, display module 14A, mirror 44, mirror 48, and input coupler 28 overlap the temple region of waveguide 26. This example is merely illustrative. Display module 14A, mirror 44, mirror 48, and input coupler 28 may instead overlap the nasal region of waveguide 26 if desired.

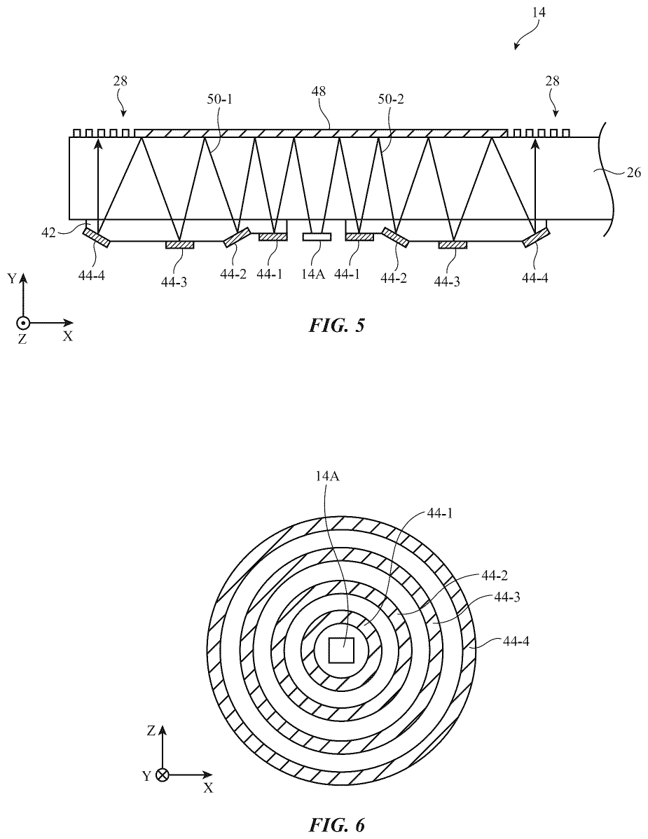

In the example of FIG. 3, one annular mirror 44 surrounds display module 14A. This example is merely illustrative. In another possible arrangement, shown in FIG. 5, multiple annular mirrors may surround display module 14A. As shown in FIG. 5, a first annular mirror 44-1 has a central opening that overlaps display module 14A, a second annular mirror 44-2 has a central opening that overlaps display module 14A and annular mirror 44-1, a third annular mirror 44-3 has a central opening that overlaps display module 14A and annular mirrors 44-1 and 44-2, and a fourth annular mirror 44-4 has a central opening that overlaps display module 14A and annular mirrors 44-1, 44-2, and 44-3.

Each one of annular mirrors 44-1, 44-2, 44-3, and 44-4 may have any of the same properties as described in connection with mirror 44 in FIG. 3. Each annular mirror may have a respective curvature and/or angle relative to the XZ-plane. Including multiple mirrors with different curvature and/or angles relative to the XZ-plane may provide additional degrees of freedom with which to control the collimation of light provided by display module 14A to input coupler 28.

In FIG. 5, a planar mirror 48 is positioned on waveguide 26 opposite annular mirrors 44. Input coupler 28 laterally surrounds planar mirror 48. FIG. 5 shows rays 50-1 and 50-2 being emitted by display module 14A and reflecting off mirrors 44-1, 44-2, 44-3, and 44-4 in that order. Planar mirror 48 reflects light multiple times as the light passes from display module 14A to input coupler 28. The light is ultimately received and redirected by input coupler 28 (as shown in connection with FIG. 3). The function of input coupler 28 is the same in FIG. 5 as in FIG. 3 and will not be discussed further in connection with FIG. 5.

The example of mirror 48 being planar is merely illustrative. If desired, mirror 48 may optionally have annular regions with curvature. Each annular region of mirror 48 may be configured to direct incident light to a respective one of mirrors 44.

In FIG. 5, annular mirrors 44-1, 44-2, 44-3, and 44-4 are coated on a common transparent structure 42. This example is merely illustrative and the mirrors may have discrete respective transparent structures if desired. As yet another alternative, transparent structure 42 may be omitted (similar as discussed in connection with FIG. 3).

FIG. 6 is a side view of annular mirrors 44 and display module 14A from FIG. 6. As shown in FIG. 6, the annular mirrors may be concentric, with each annular mirror having a central opening that overlaps display module 14A.

For the annular mirrors described herein in connection with FIGS. 3 and 5, the curvature and/or angle of the mirror relative to the XZ-plane may remain constant around the circumference of the annular mirror. The example in FIG. 5 of including four discrete annular mirrors is merely illustrative. In general, any desired number of annular mirrors may be used (e.g., one, two, three, four, more than four, more than five, more than eight, etc.).

It is noted that, in FIG. 3, mirrors 44 and 48 as well as transparent structures 42 and 46 may collectively be referred to as collimating optics 34. In FIG. 5, mirrors 44-1, 44-2, 44-3, 44-4, and 48 as well as transparent structure 42 may collectively be referred to as collimating optics 34.

The mirrors described herein may have spherical curvature, aspherical curvature, or free form curvature.

The collimating optics of FIGS. 3 and 5 may advantageously be lightweight, compact, and have a low cost and complexity. The compact design may allow greater flexibility in the integration of the collimating optics into system 10.

The foregoing is merely illustrative and various modifications can be made to the described embodiments. The foregoing embodiments may be implemented individually or in any combination.

What is claimed is:

1. A display system comprising:
a waveguide having first and second opposing sides;
a first mirror on the first side of the waveguide;
a display module on the second side of the waveguide that produces image light; and
a second mirror on the second side of the waveguide, wherein the second mirror has an annular footprint with a central opening and wherein the display module and the first mirror overlap the central opening.

2. The display system defined in claim 1, wherein the image light produced by the display module passes through the waveguide from the second side towards the first side, then reflect off the first mirror, then passes through the waveguide from the first side towards the second side, and then reflects off the second mirror.

3. The display system defined in claim 1, further comprising:
an annular input coupler on the first side of the waveguide, wherein the annular input coupler has an additional central opening and wherein the display module and the first mirror overlap the additional central opening.

4. The display system defined in claim 3, wherein the image light produced by the display module passes through the waveguide from the second side towards the first side, then reflects off the first mirror, then passes through the waveguide from the first side towards the second side, then reflects off the second mirror, then passes through the waveguide from the second side towards the first side, and then is redirected by the annular input coupler.

5. The display system defined in claim 3, wherein the annular input coupler comprises a surface relief grating.

6. The display system defined in claim 3, further comprising:
an output coupler that redirects the image light towards an eye box on the second side of the waveguide.

7. The display system defined in claim 3, further comprising:
an output coupler that redirects the image light towards an eye box on the first side of the waveguide.

8. The display system defined in claim 3, wherein the second mirror has a surface with concave curvature that faces the annular input coupler.

9. The display system defined in claim 1, wherein the waveguide has a temple region and a nasal region and wherein the display module and the first and second mirrors overlap the temple region.

10. The display system defined in claim 1, wherein the waveguide has a temple region and a nasal region and wherein the display module and the first and second mirrors overlap the nasal region.

11. The display system defined in claim 1, wherein the first mirror has a surface with convex curvature that faces the display module.

12. The display system defined in claim 1, further comprising:
a third mirror on the second side of the waveguide, wherein the third mirror has an additional annular footprint with an additional central opening and wherein the third mirror is formed within the central opening of the second mirror.

13. The display system defined in claim 1, further comprising:
an output coupler that redirects the image light towards an eye box on the first side of the waveguide.

14. The display system defined in claim 1, further comprising:
an output coupler that redirects the image light towards an eye box on the second side of the waveguide.

15. A display system comprising:
a waveguide having first and second opposing sides;
a first mirror on the first side of the waveguide;
a surface relief grating on the first side of the waveguide, wherein the surface relief grating has a first annular footprint with a first central opening and wherein the first mirror overlaps the first central opening;
a display module on the second side of the waveguide that produces image light that passes through the first central opening to reach the first mirror; and
a second mirror on the second side of the waveguide that receives the image light from the first mirror.

16. The display system defined in claim 15, wherein the second mirror has a second annular footprint with a second central opening and wherein the display module and the first mirror overlap the second central opening.

17. The display system defined in claim 15, wherein the surface relief grating redirects the image light from the second mirror to propagate by total internal reflection across the waveguide.

18. The display system defined in claim 15, wherein the first mirror has a convex surface that receives the image light from the display module.

19. The display system defined in claim 15, wherein the second mirror has a concave surface that receives the image light from the first mirror.

20. A display system comprising:
a waveguide having first and second opposing sides;
a display module that produces image light;
an input coupler on the waveguide that couples the image light into the waveguide; and
collimating optics that collimate the image light from the display module for the input coupler, wherein the collimating optics comprise a first mirror on the first side of the waveguide and a second mirror on the second side of the waveguide.

21. The display system defined in claim 20, wherein the display module is positioned on the first side of the waveguide and wherein the input coupler is positioned on the second side of the waveguide.

22. The display system defined in claim 21, wherein the image light passes through a thickness of the waveguide three times between leaving the display module and reaching the input coupler.
